(19) United States
(12) Patent Application Publication
(10) Pub. No.: US 2009/0094277 A1
(43) Pub. Date: Apr. 9, 2009

(54) AUTOMATIC OPTIMIZATION OF DISPLAY LAYOUT FOR MOBILE DEVICES

(76) Inventors: Ann Mead Corrao, Raleigh, NC (US); Brian Marshall O'Connell, Cary, NC (US); Brian James Snitzer, Lancaster, PA (US); Keith Raymond Walker, Austin, TX (US)

Correspondence Address: IBM CORP (YA);C/O YEE & ASSOCIATES PC, P.O. BOX 802333, DALLAS, TX, 75380, US

(21) Appl. No.: 11/866,895

(22) Filed: Oct. 3, 2007

(51) Int. Cl. G06F 17/00; H04M 1/00

(52) U.S. Cl. 707/104.1; 455/550.1; 707/E17.009

(57) ABSTRACT

A computer implemented method, a computer program product, and a mobile device are disclosed for presenting a list of invokable actions to a user of the mobile device. Responsive to identifying the commencing of the invokable action, specific attributes of the invokable action are identified and stored in a corresponding data structure. From the specific attributes stored within the corresponding data structure, a most probable invokable action is identified. When the commencing of a subsequent invokable action is identified, the most probable invokable action is presented to the user.

### BACKGROUND OF THE INVENTION

1. Field of the Invention

The present invention relates generally to computer implemented methods, computer program products, and mobile devices. More specifically, the present invention relates to computer implemented methods, computer program products and mobile devices for presenting a list of invokable actions to a user of the mobile device.

2. Description of the Related Art

Presently, there exist over 1.8 billion mobile phone and device users. Mobile devices share several traits including, but not limited to, input capability such as a stylus, a small keyboard, a numerical dial pad, a touch screen, and a small display size. Users must operate these devices with limited input functions and limited display size.

Presently, mobile devices do not fully optimize their limited screen real-estate, resulting in excess input operations for users to locate information and invoke mobile device functions. Mobile devices have many invokable actions, but limited screen real-estate hinders navigation, resulting in difficulty invoking actions. For example, mobile devices are used to instant message, place calls, and access weather forecasts. Unfortunately, with the increase in function the list of options to choose from becomes cumbersome on a small device. It may take a long time to scroll through all the options that one may wish to initiate on their cell phone. Furthermore, the increased number of functions may add complexity and usability problems with the limited display area on many mobile devices.

Currently, display and input optimizations exist for smaller mobile displays and devices with limited input components. For example, it is common on cellular phones for the number keys to map present invokable actions on the devices display. In another example, smaller display devices that contain web browsers often have functions to zoom out and zoom in on displayed web pages, which ease navigation on large web pages. Other non-disqualifying art exists for optimizing mobile displays.

### SUMMARY OF THE INVENTION

A computer implemented method, a computer program product, and a mobile device are disclosed for presenting a list of invokable actions to a user of the mobile device. Responsive to identifying the commencing of the invokable action, specific attributes of the invokable action are identified and stored in a corresponding data structure. From the specific attributes stored within the corresponding data structure, a most probable invokable action is identified. When the commencing of a subsequent invokable action is identified, the most probable invokable action is presented to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a mobile telephone in which the illustrative embodiments may be implemented;

FIG. 2 is an exemplary block diagram of a wireless communication device in which the illustrative embodiments may be implemented;

FIG. 3 is a data flow diagram depicting the interaction between various components in which illustrative embodiments may be implemented;

FIG. 4 is a table of activities storing information related to invokable actions in which illustrative embodiments may be implemented;

FIG. 5 is a process for collecting information to be stored in a table of activities in which illustrative embodiments may be implemented;

FIG. 6 is a process for identifying a most probable invokable action under a given set of circumstances in which illustrative embodiments may be implemented; and

FIG. 7 is a process for presenting a current iteration of a hierarchal list of invokable actions to a user in which illustrative embodiments may be implemented.

### DETAILED DESCRIPTION OF THE PREFERRED EMBODIMENT

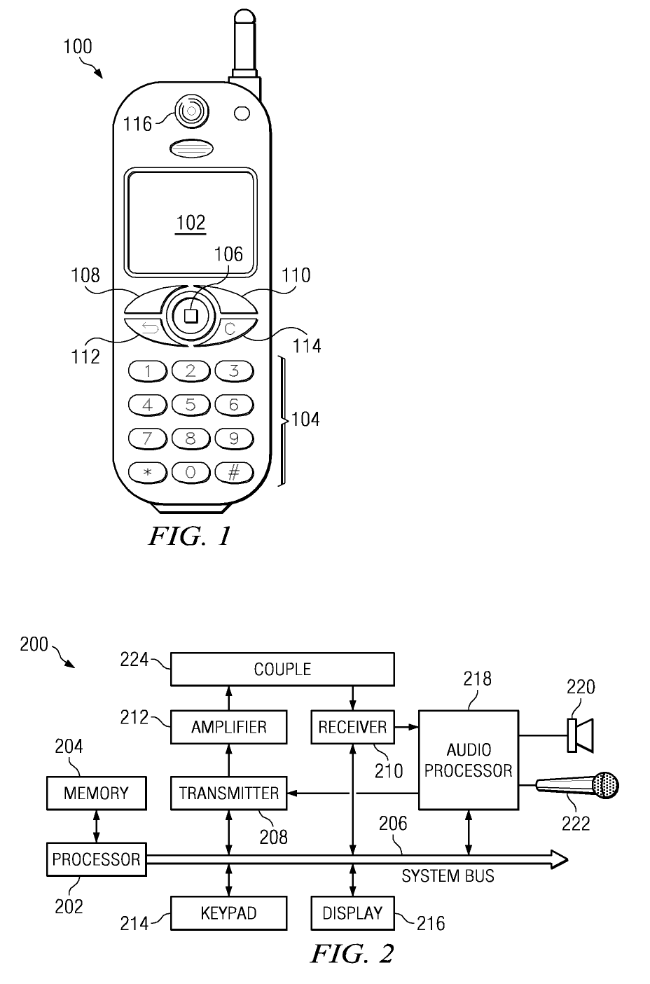

With reference now to the figures and in particular with reference to FIG. 1, a mobile telephone is depicted in which the illustrative embodiments may be implemented. Mobile phone 100 includes screen 102, which is capable of displaying pictures and text. Additionally, mobile phone 100 also includes numeric keypad 104, joystick 106, and buttons 108, 110, 112, and 114 placed around the joystick 106. These buttons are used to initiate various functions in mobile phone 100. These functions include for example, activating a menu, displaying a calendar, or initiating a call. Mobile phone 100 also includes camera 116, which may be used to take pictures or videos depending on the implementation.

FIG. 2 is an exemplary block diagram of a wireless communication device in which the illustrative embodiments may be implemented. Wireless communication device 200 can be mobile phone 100 of FIG. 1. Wireless communication device 200 includes a processor 202 for controlling operation of the communication device and a memory 204. The processor 202 may be a general-purpose microprocessor operating under the control of instructions stored in a memory, such as memory 204, or device-specific circuitry for controlling the operation of the telephone device. Processor 202 is connected by system bus 206 to transmitter 208, receiver 210, keypad 214, display 216, and audio processor 218. Keypad 214 may be a keypad and/or buttons. Display 216 may be any type of display device including a liquid crystal display (LCD) or other known displays, such as a cathode ray tube or active matrix display.

Transmitter 208 and receiver 210 are coupled to a telephone signal by couple 224 to provide full duplex communication. The telephone signal may be provided by a telephone line (not shown) in a land-based telephone or an antenna, such as for a wireless telephone. Audio processing circuit 218 provides basic analog audio outputs to speaker 220 and accepts analog audio inputs from microphone 222. Received signals are demodulated and decoded by receiver 210. Transmitter 208 encodes and modulates signals passed to it by processor 202 or audio processor 218. The output of the transmitter is amplified by power amplifier 212 to control the power level at which the signal is transmitted.

Processor 202 or audio processor 218 may detect audible call status information and call status codes received by receiver 210. Memory 204 may include a lookup table associating call status information or call status codes with visual call status information, such as text messages. Processor 202 detects or receives a call status code and displays an appropriate call status message on display 216. Those of ordinary skill in the art will appreciate that the hardware depicted in FIG. 2 may vary.

The illustrative embodiments describe a computer implemented method, computer program products, and data processing systems to exploit identifiable mobile device usage patterns to optimize the display of mobile devices by automatically presenting the actions most probable to be invoked by a user. This system detects usage patters by monitoring the frequency of invocation, location of the cell phone, day of the week, and time. Such a system enables the mobile device to dynamically change the displayed invokable actions to the actions most probable to be invoked during that day of the week, at that location of the mobile device, during a particular time of the day.

The illustrative embodiments allow the users to quickly access their most probable used mobile device applications at the location and time when they may need them. The invention only displays the most probable used options during a particular time of day and at a particular location.

The illustrative embodiments determine the most probable invokable actions based on location, time of day and day of week. Three components are described to enable this invention. An action detection component captures when an action is invoked on a mobile device. A data collection component stores usage data and dimensional data (location, time, day of week). The third component ranks the stored data to selectively display probable invokable actions based on changes of location and time.

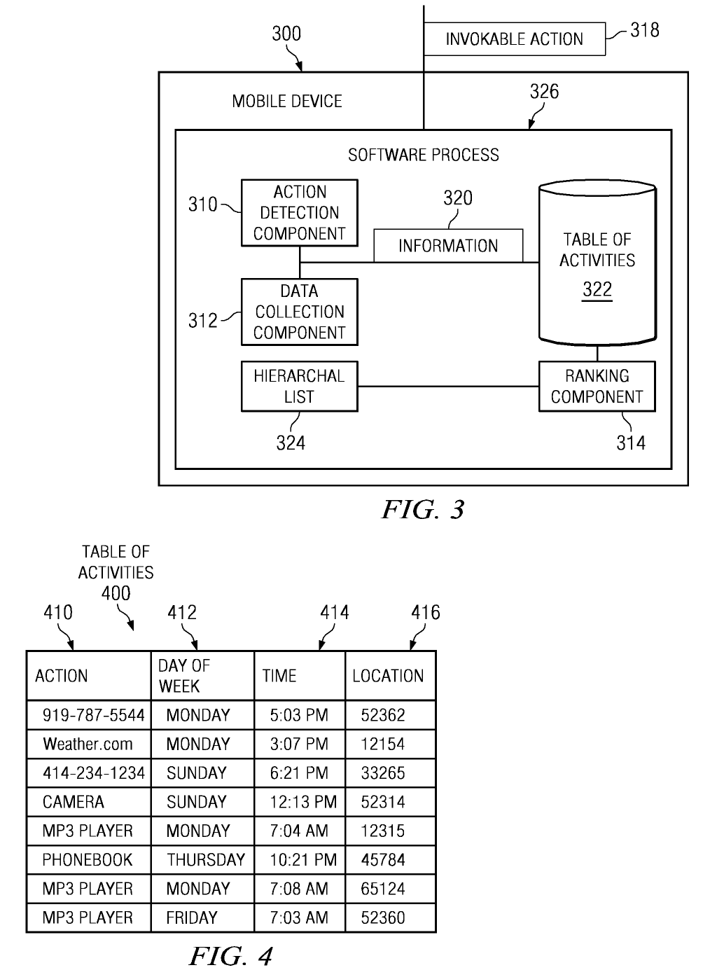

Referring now to FIG. 3, a data flow diagram is shown depicting the interaction between various components in which illustrative embodiments may be implemented. Action detection component 310, data collection component 312, and ranking component 314 are software components executing on a wireless communication device, such as wireless communication device 200 of FIG. 2.

As described above, invokable action 318 can be performed on mobile device 300. Invokable action 318 is any function a mobile device can perform. For example, dialing a phone number, accessing a web browser to view a website, accessing an appointment book, accessing an email application, and accessing a text messaging application are all invokable actions. Action detection component 310 detects the initiation or performance of invokable action 318. Action detection component 310 is a software component executing on a wireless communication device, such as wireless communication device 200 of FIG. 2.

Responsive to the detection of invokable action 318, action detection component 310 notifies, or otherwise triggers the execution of data collection component 312. Data collection component 312 is a software component that retrieves and stores information 320 related to invokable action 318 any time invokable action 318 is initiated or performed.

Information 320 is data regarding specific attributes of invokable action 318. Attributes may include, but are not limited to, the specific invokable action taken, the time and date at which the invokable action was performed, and the location at which the invokable action was performed. Information 320, including the specific attributes thereof, is stored in table of activities 322. Table of activities 322 is a data structure which stores information 320 related to invokable action 318.

The illustration of components in FIG. 3 are for purposes of describing one illustrative embodiment and not meant to limit the manner in which features of the embodiments may be implemented. For example, 3 functional components are depicted, but in some implementations, functional components and features could be combined into a single component and other implementations additional components may be used to implement the features of the illustrative embodiments.

Referring now to FIG. 4, a table of activities is shown for storing information related to invokable actions in which illustrative embodiments may be implemented. Table of activities 400 can be table of activities 322 of FIG. 3. Action 410 is a list of the specific invokable actions taken by the mobile device. Action 410 can include but is not limited to: calling a telephone number, using the internet to search a website or launching the calendar application. Actions 410 may be stored with additional descriptive detail such as, for example, without limitation, the number dialed and web site visited.

Day of week 412 is the day on which invokable action 318 of FIG. 3 was performed. Day of week 412 is available on most mobile devices through date, time and calendaring functions. The day of the week is pertinent because a user's action invocation patterns may be influenced by the day of the week. For example, one user may call a number (home) before leaving the office Monday through Friday, however on the weekends the user never calls home during that time period. Day of week 412 can be used by ranking component 314 of FIG. 3 when deriving the most probable used action.

Time 414 is the daily time at which invokable action 318 of FIG. 3 was performed. The current time is available on most mobile device's date, time and calendaring functions. The current time is associated with each inserted entry into the data store. Time 414 can be used by ranking component 314 of FIG. 3 when deriving the most probable used action.

Location 416 is the location at which the invokable action 318 of FIG. 3 was performed. In 2005 all cell phone carriers were required to provide the ability to trace cell phones calls to within 100 meters of a location using global positioning system tracking. Additionally, there exists a technology called passive tracking that is not available on all phones, but is common on newer phones. Passive tracking is also referred to as “data logging” and can provide location data even when the device has traveled outside the wireless network. The function of passive tracking is unique to cell phones, but with augmentation may be applied to other mobile devices. Other embodiments may define location as a triangulation between cellular towers. The location is associated with each entry into the data store. Location 416 can be used by ranking component 314 of FIG. 3 when deriving the most probable used action.

While location 416 is represented as an integer in FIG. 4, the format of location 416 may vary with the specific embodiments. For example, location 416 may also be global positioning system (GPS) coordinates or triangulation data, such as relative signal strengths to proximate cell phone towers.

Referring now again to FIG. 3, responsive to detecting invokable action 318, action detection component 310 notifies, or otherwise triggers the execution of, data ranking component 314. Ranking component 314 is a software component executing on wireless communication device, such as wireless communication device 200 of FIG. 2.

Ranking component 314 identifies the most probable invokable action 318 at any given time, location and date using information 320 stored in table of activities 322. Depending on the embodiment, ranking component 314 may be invoked at time intervals, for example every 30 seconds, every minute. In other embodiments, the component may be invoked when a change in location is detected. Yet still in other embodiments, the component may be invoked when the user lifts the mobile device, rouses the device from a standby mode, or performs other actions indicating that receipt of invokable action 318 is imminent.

While various algorithms, formulae and matrices might be used to compute the most probable invokable action 318, each of these predicts the most probable to be invoked actions at any time and locations according to information 320 stored in table of activities 322. Some embodiments may favor temporal proximity over location proximity, others may have reverse preferences. Yet, still other embodiments may use analytics of previously selected items from ranked probable actions to favor temporal proximity over location proximity or vice versa. For example, if a user consistently chooses items closer in temporal proximity rather than location proximity the ranking component may adjust its algorithm to favor temporal proximity.

Based on the computations of ranking component 314, ranking component creates hierarchal list 324. Hierarchal list 324 is a data structure containing a listing of possible invokable actions. Invokable actions having a higher probability of corresponding to invokable action 318, based on the current iteration of hierarchal list 324 are presented earlier in hierarchal list 324.

Responsive to the detection of invokable action 318, software process 326 presents the current iteration of hierarchal list 324 to a user. By determining the most probable invokable action 318, the presently described embodiments allow the user to avoid needlessly navigating numerous menu options attempting to find the desired invokable action 318.

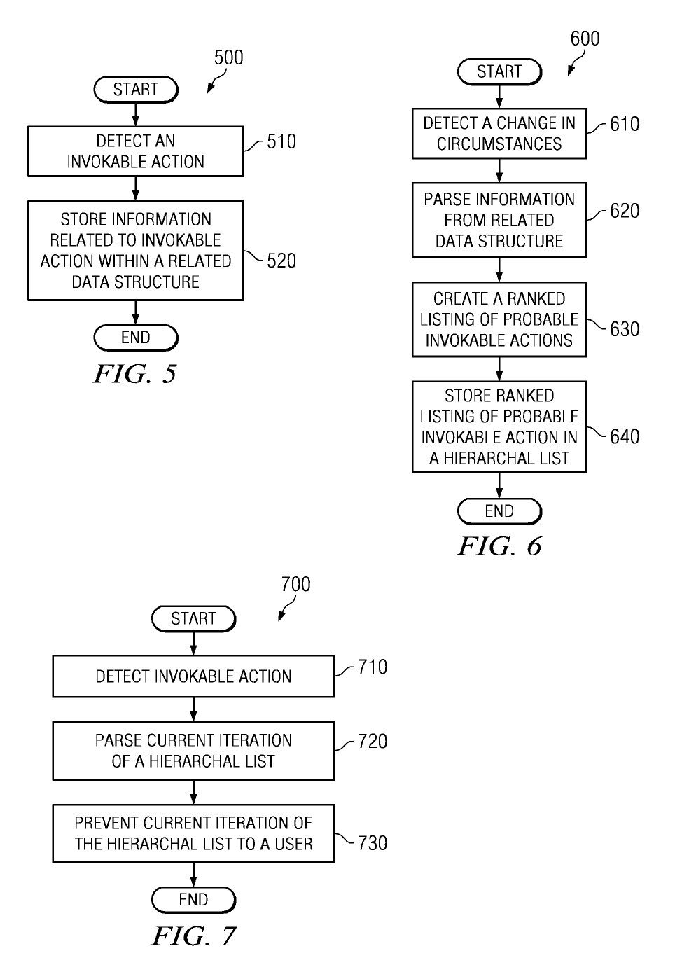

Referring now to FIG. 5, a process for collecting information to be stored in a table of activities is shown in which illustrative embodiments may be implemented. Process 500 is a software process executing on a software component, such as data collection component 312 of FIG. 3. Process 500 stores information related to an invokable action any time an invokable action is initiated or performed. Information is stored within a related data structure, such as table of activities 322 of FIG. 3.

Process 500 begins by detecting an invokable action (step 510). An invokable action, such as invokable action 318 of FIG. 3, is any function a mobile device can perform. For example, dialing a phone number, surfing a website such as weather.com, reviewing the appointment book, and email are all invokable actions.

Responsive to detecting an invokable action, process 500 stores information related to the invokable action within a related data structure (step 520), with the process terminating thereafter. Information can be information 320 of FIG. 3. Information is data regarding a set of specific attributes of the invokable action. The set of specific attributes may include, but are not limited to, one of more of the specific invokable action taken, the time and date at which the invokable action was performed, and the location at which the invokable action was performed. Information, including the specific attributes thereof, is stored in a table of activities. The related data structure can be Table of activities 322 of FIG. 3. The related data structure is a data structure which stores information related to the invokable action.

Referring now to FIG. 6, a process for identifying a most probable invokable action under a given set of circumstances is shown in which illustrative embodiments may be implemented. Process 600 is a software process executing on a software component, such as ranking component 314 of FIG. 3.

Process 600 begins by detecting a change in circumstances (step 610). A change in circumstances is a present change related to any of the attributes stored in a related data structure, such as table of activities 322 of FIG. 3. Depending on the embodiment, a change in circumstances may be an incrementing of a predetermined time interval, for example every 30 seconds, every minute. In other embodiments, a change in circumstances may occur when a change in location is detected. In other embodiments, a change in circumstances may occur when the user lifts the mobile device, rouses the device from a standby mode, or performs other actions indicating receipt of invokable action 318 is imminent.

Responsive to detecting a change in circumstances, process 600 parses information from the related data structure (step 620). Process 600 then creates a ranked listing of probable invokable actions (step 630). Process 600 identifies the most probable invokable action at any given time, location and date using information stored in the related data structure.

While various algorithms and matrices might be used to compute the most probable invokable action, each of these predicts the most probable to be invoked actions at any time and locations according to information stored in the related data structure. Some embodiments may favor temporal proximity over location proximity, others may have reverse preferences. Yet, still other embodiments may use analytics of selected items from ranked probable actions to favor temporal proximity over location proximity or vice versa. For example, if a user consistently chooses items closer in temporal proximity rather than location proximity the ranking component may adjust its algorithm to favor temporal proximity.

Responsive to creating a ranked listing of probable invokable actions, process 600 stores the ranked listing of probable invokable actions in a hierarchal list (step 640), with the process terminating thereafter. The hierarchal list, which can be hierarchal list 324 of FIG. 3, is a data structure containing the ranked listing of possible invokable actions. Invokable actions having a higher probability of corresponding to invokable action based on the current iteration of the hierarchal list are presented earlier in the hierarchal list.

Referring now to FIG. 7, a process for presenting a current iteration of a hierarchal list of invokable actions to a user is shown in which illustrative embodiments may be implemented. Process 700 is a software process executing on a software component, such as software component 326 of FIG. 3.

Process 700 begins by detecting an invokable action (step 710). An invokable action, such as invokable action 318 of FIG. 3, is any function a mobile device can perform. For example, dialing a phone number, surfing a website such as weather.com, reviewing the appointment book, and email are all invokable actions.

Responsive to the detection of an invokable action, process 700 parses a current iteration of a hierarchal list (step 720). The hierarchal list is a data structure containing the ranked listing of possible invokable actions. Invokable actions having a higher probability of corresponding to an invokable action based on the current iteration of hierarchal list are presented earlier in the hierarchal list.

Responsive to parsing the hierarchal list, process 700 presents the current iteration of the hierarchal list to a user (step 730), with the process terminating thereafter. Invokable actions that are more probable given the current circumstances are presented to the user prior to those invokable actions that have a lower probability of corresponding to the desired invokable action. By determining the most probable invokable action, the presently described embodiments allow the user to avoid needlessly navigating numerous menu options attempting to find the desired invokable action.

Thus, the illustrative embodiments describe methods, computer program products, and data processing systems to exploit identifiable mobile device usage patterns to optimize the display of mobile devices by automatically presenting the actions mostly probable to be invoked by a user. This system detects usage patters by monitoring the frequency of invocation, location of the cell phone, day of the week, and time. Such a system enables the mobile device to dynamically change the displayed invokable actions to the actions most probable to be invoked during that day of the week, at that location of the mobile device, during a particular time of the day.

The illustrative embodiments allow the users to quickly access their most probable used mobile device applications at the location and time when they may need it. The invention only displays the most probable used options during a particular time of day and at a particular location.

The illustrative embodiments determine the most probable invokable actions based on location, time of day and day of week. Three components are described to enable this invention. An action detection component captures when an action is invoked on a mobile device. A data collection component is required to store usage data and dimensional data (location, time, day of week). The third component ranks the stored data to select the display of probable invokable action based on changes of location and time.

The invention can take the form of an entirely hardware embodiment, an entirely software embodiment or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing device,) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for presenting a list of invokable actions to a user of a mobile device, the method comprising:
identifying a commencing of an invokable action;
responsive to identifying the commencing of the invokable action, identifying a set of specific attributes of the invokable action and storing the set of specific attributes in a data structure;
identifying a most probable invokable action from the data structure; and
responsive to identifying the commencing of an invokable action, presenting the most probable invokable action to a user.

2. The computer implemented method of claim 1, wherein the invokable action is selected from actions comprising dialing a phone number, accessing a web browser to view a website, accessing an appointment book, accessing an email application, and accessing a text messaging application.

3. The computer implemented method of claim 1, wherein the at least one specific attribute comprises at least one of a specific invokable action, a time the specific invokable action was commenced, a date the specific invokable action was commenced, and a location at the specific invokable action was commenced.

4. The computer implemented method of claim 1, wherein the most probable invokable action is identified at a predetermined time interval, when a change in location is identified, when the user lifts the mobile device, or when the user rouses the mobile device from a standby mode.

5. The computer implemented method of claim 1, wherein an algorithm, a formula or a matrix identifies the most probable invokable action from the at least one specific attribute in the data structure.

6. The computer implemented method of claim 5, wherein the algorithm, the formula or the matrix favors one of a temporal proximity, a location proximity, or an analytic of previously selected invokable actions.

7. The computer implemented method of claim 1, wherein the step of presenting the most probable invokable action to a user further comprises:
presenting a hierarchal list of probable invokable actions to the user, wherein the most probable invokable action is presented first in the hierarchal list.

8. The computer implemented method of claim 1, wherein the mobile device is a wireless communication device.

9. The computer implemented method of claim 8, wherein the mobile device is a mobile telephone.

10. A computer program product comprising:
a computer readable medium having computer usable program code presenting a list of invokable actions to a user of a mobile device, the computer program product comprising:
computer usable program code for identifying the commencing of an invokable action;
computer usable program code, responsive to identifying the commencing of the invokable action, for identifying a set of specific attributes of the invokable action and storing the at least one specific attribute in a data structure;
computer usable program code for identifying a most probable invokable action from the data structure; and
computer usable program code, responsive to identifying the commencing of an invokable action, for presenting the most probable invokable action to a user.

11. The computer program product of claim 10, wherein the invokable action is selected from actions comprising dialing a phone number, accessing a web browser to view a website, accessing an appointment book, accessing an email application, accessing a text messaging application.

12. The computer program product of claim 10, wherein the at least one specific attribute comprising at least one of a specific invokable action, a time the specific invokable action was commenced, a date the specific invokable action was commenced, and a location at the specific invokable action was commenced.

13. The computer program product of claim 10, wherein the most probable invokable action is identified under one of the circumstances of: identified at a predetermined time interval, identified when a change in location is identified, identified when the user lifts the mobile device, or identified when the user rouses the mobile device from a standby mode.

14. The computer program product of claim 10, wherein an algorithm, a formula or a matrix identifies the most probable invokable action from the at least one specific attribute in the data structure.

15. The computer program product of claim 14, wherein the algorithm, the formula or the matrix favors one of a temporal proximity, a location proximity, or an analytic of previously selected invokable actions.

16. The computer program product of claim 10, wherein the computer usable program code for presenting the most probable invokable action to a user further comprises computer usable program code for presenting a hierarchal list of probable invokable actions to the user, wherein the most probable invokable action is presented first in the hierarchal list.

17. The computer program product of claim 10, wherein the mobile device is a wireless communication device.

18. The computer program product of claim 17, wherein the mobile device is a mobile telephone.

19. A mobile device comprising:
a bus;
a communications unit connected to the bus;
a storage device connected to the bus, wherein the storage device includes computer usable program code; and
a processor unit connected to the bus, wherein the processor unit executes the computer usable program code to identify the commencing of an invokable action, responsive to identifying the commencing of the invokable action, to identify at least one specific attribute of the invokable action and to store the at least one specific attribute in a data structure, to identify a most probable invokable action from the data structure, and responsive to identifying the commencing of an invokable action, to present the most probable invokable action to a user.

20. The mobile device of claim 19, wherein the processor unit executing the computer usable program code to present the most probable invokable action to a user further comprises the processor unit executing the computer usable program code to present a hierarchal list of probable invokable actions to the user, wherein the most probable invokable action is presented first in the hierarchal list.
